(19) United States
(12) Patent Application Publication
(10) Pub. No.: US 2009/0111505 A1
(43) Pub. Date: Apr. 30, 2009

(54) PORTABLE TERMINAL, NETWORK SERVER, NETWORK SYSTEM, NETWORK COMMUNICATION METHOD AND PROGRAM

(75) Inventors: Tetsuji Sumita, Kanagawa (JP); Kazuma Shiga, Kanagawa (JP)

Correspondence Address: PEARNE & GORDON LLP, 1801 EAST 9TH STREET, SUITE 1200, CLEVELAND, OH, 44114-3108, US

(73) Assignee: Matsushita Electric Industrial Co., Ltd., Osaka (JP)

(21) Appl. No.: 11/718,543

(22) PCT Filed: Jan. 26, 2006
(86) PCT No.: PCT/JP2006/301220

§ 371 Date: May 3, 2007

(30) Foreign Application Priority Data
Jan. 26, 2005 (JP) 2005-018522

(51) Int. Cl. H04M 1/00; G09G 5/00; G06F 15/16

(52) U.S. Cl. 455/550.1; 345/156; 709/217

(57) ABSTRACT

The technology that is capable of causing operation keys of a mobile terminal to flexibly deal with external data such as a new program, or the like, and also improving an operability of the mobile terminal in handling the external data can be provided. In the network system 300, a mobile terminal 100 transmits transmitted information containing operation information, which corresponds to an amount of physical operation in a user's operation applied to an operation inputting portion 121, 119, to a server 200, and then the server 200 generates information containing the operation information and then transmits the information to the mobile terminal 100 via a network 400.

### TECHNICAL FIELD

The present invention relates to the technology to improve an operability of a mobile terminal and, more particularly, a mobile terminal, a network server, a network system, a network communication method and program to realize such technology.

### BACKGROUND ART

Various technologies have been developed to improve an operability of the mobile terminal. For example, Patent Literature 1 discloses the technology to change a moving speed of the cursor in response to strength of key press.

Also, Patent Literature 2 offered the technology that selects the optimal process from a plurality of options in response to strength of key touch so as to render the different processes executable without change of the key to be pressed.

In addition, Patent Literature 3 discloses the technology to change a scrolling speed in response to a speed or strength of a scrolling operation of the operation device.
Patent Literature 1: JP-A-61-165791
Patent Literature 2: JP-A-4-319719
Patent Literature 3: JP-A-2001-304880

### DISCLOSURE OF THE INVENTION

### Problems that the Invention is to Solve

In above Literatures, the type of predetermined process is converted in response to strength of the key operation without change of the key to be pressed. For example, Patent Literatures 1, 2 change a movement of the cursor or a speed of the scroll in answer to strength of the key operation. Also, Patent Literature 3 executes the switching between a page feeding process and a scrolling process in answer to strength of the key operation.

However, improvement in a key operability is further demanded with the spread of mobile terminal. In particular, through the spread of downloading of program, contents, applications, etc. by the mobile terminal, the key operation responding to the program, or the like is required of the terminal.

The prior arts aim at improving a key operability by making it possible to execute the process, which needs plural key operations up to now, by using one key. But these prior arts did not mention at all that a new process executed in response to strength of the key operation should be added. Therefore, even though the terminal downloaded newly the program, or the like from the network server, it is difficult for such terminal to run the downloaded program, or the like when the information corresponding to predetermined key operations, which are needed to run the program, or the like, have not been installed into such terminal.

The present invention provides the technology capable of causing operation keys of a mobile terminal to flexibly deal with external data such as a new program, or the like, and also improving an operability of the mobile terminal in handling the external data.

### Means for Solving the Problems

A mobile terminal of the present invention, includes an operation inputting portion for inputting a user's operation; a sensing device for sensing the user's operation applied to the operation inputting portion and sensing an amount of physical operation in the operation; a receiving portion for receiving received information containing operation information corresponding to the amount of physical operation from an outside; an image generating portion for generating an image representing the operation information by interpreting the received information; a displaying portion for displaying the image; a transmitted information generating portion for generating transmitted information containing designated information designated by the user who looks up the operation information in the displayed image; and a transmitting portion for transmitting the transmitted information to the outside; wherein the designated information responds to the amount of physical operation in the user's operation applied to the operation inputting portion, and is sensed by the sensing device.

According to this configuration, the operation information of the operation inputting portion can be received and the operation information can be displayed on the display portion. The user can designate the designated information in response to an amount of physical operation of the operation inputting portion by looking at this display, and can transmit this information to the outside. Therefore, the operating process of the mobile terminal can be suited flexibly in response to the operation information, and an operability of the mobile terminal can be improved.

The received information can be composed of a language containing a supplementary description corresponding to the operation information. Also, the display portion can be constructed by a pseudo three-dimensional display that displays a pseudo three-dimensional screen.

According to this configuration, an operability based on the user's intuition can be improved.

In addition, the operation inputting portion can be constructed by a button. In this case, the amount of physical operation corresponds to at least any one of a pressing force on the button, a pressing speed on the button, and a pressing time on the button.

According to this configuration, an operability based on the user's intuition can be further improved.

Further, the display portion displays a pseudo three-dimensional screen, and the pseudo three-dimensional screen represents a pseudo depth display corresponding to at least any one of a pressing force, a pressing speed, and a pressing time on the button when the operation information is represented by a three-dimensional display.

According to this configuration, an operability based on the user's intuition can be further improved.

Also, a network server of the present invention that is able to communicate with a mobile terminal via a network, includes a receiving portion for receiving received information from the mobile terminal; a deciding portion for deciding whether or not the received information contains a request for operation information corresponding to an amount of physical operation of an operation applied to an operation inputting portion of the mobile terminal; a transmitted information generating portion for generating transmitted information containing the operation information when it is decided that the received information contains the request for the operation information; and a transmitting portion for transmitting the transmitted information to the mobile terminal.

According to this configuration, the operation information can be transmitted to the mobile terminal. Therefore, the operating process of the mobile terminal can be suited flexibly in response to the operation information, and an operability of the mobile terminal can be improved.

The above network server can further include a storage device for storing the operation information.

According to this configuration, the particular program, the markup language, the script language, or the like containing the operation information can be prepared in advance, and transmission of the operation information can be made simple.

Also, the present invention can provide a network system, which includes a mobile terminal for transmitting/receiving transmitted information and received information containing operation information that corresponds to an amount of physical operation in a user's operation applied to an operation inputting portion; a network server for receiving the transmitted information to generate information containing the operation information, and transmitting the information to the mobile terminal; and a network for connecting the mobile terminal and the network server to allow mutual communication.

According to this system, the operating process of the mobile terminal can be suited flexibly in response to the operation information, and an operability of the mobile terminal can be improved.

Also, the present invention can provide a network communicating method, which includes steps of receiving received information from a mobile terminal; deciding whether or not transmission of operation information corresponding to an amount of physical operation in an operation applied to an operation inputting portion of the mobile terminal is needed, based on the received information; and generating transmitted information containing the operation information when it is decided that the transmission of the operation information is needed, and then transmitting the transmitted information to the mobile terminal.

According to this communicating method, the operating process of the mobile terminal can be suited flexibly in response to the operation information, and an operability of the mobile terminal can be improved.

Also, a program of causing a computer to execute the above network communication method is contained in the present invention.

### Advantage of the Invention

According to the present invention, it is possible to cause operation keys of a mobile terminal to flexibly deal with the external data such as the new program, or the like, and also an operability of the mobile terminal in handling the external data can be improved.

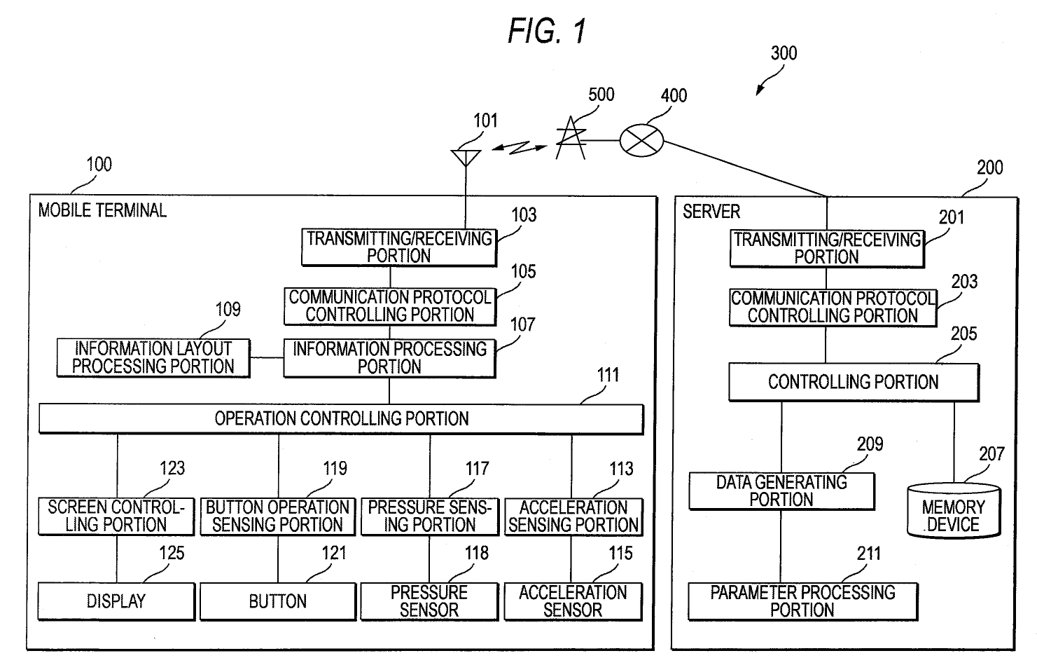

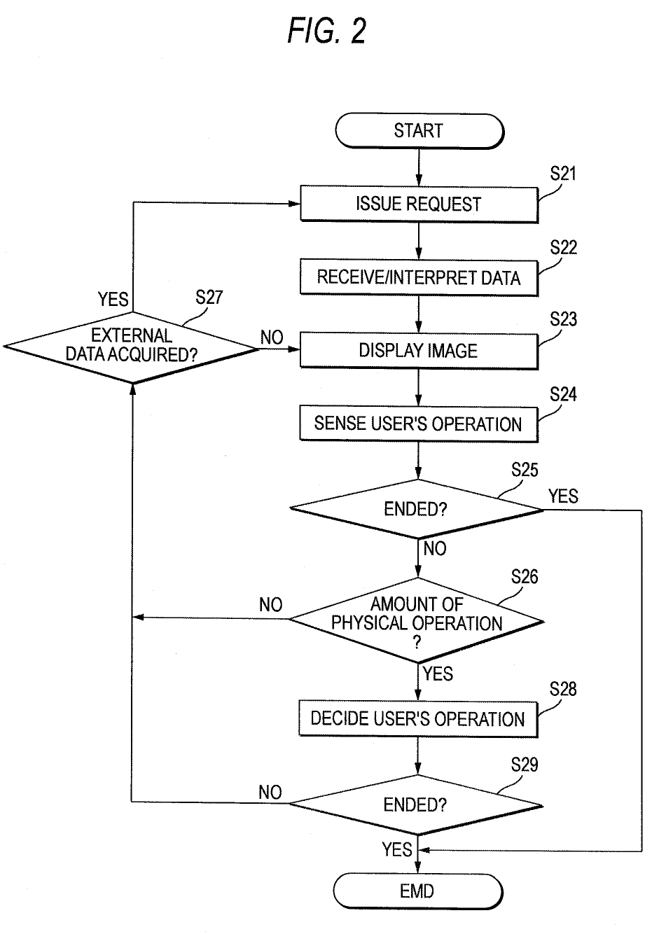

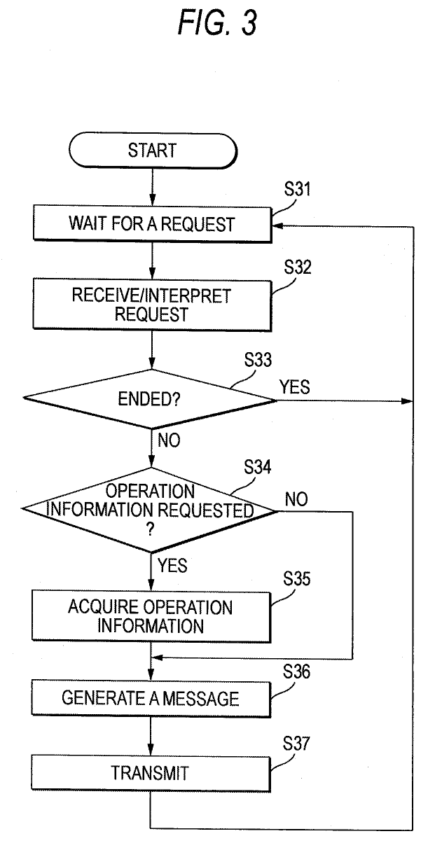

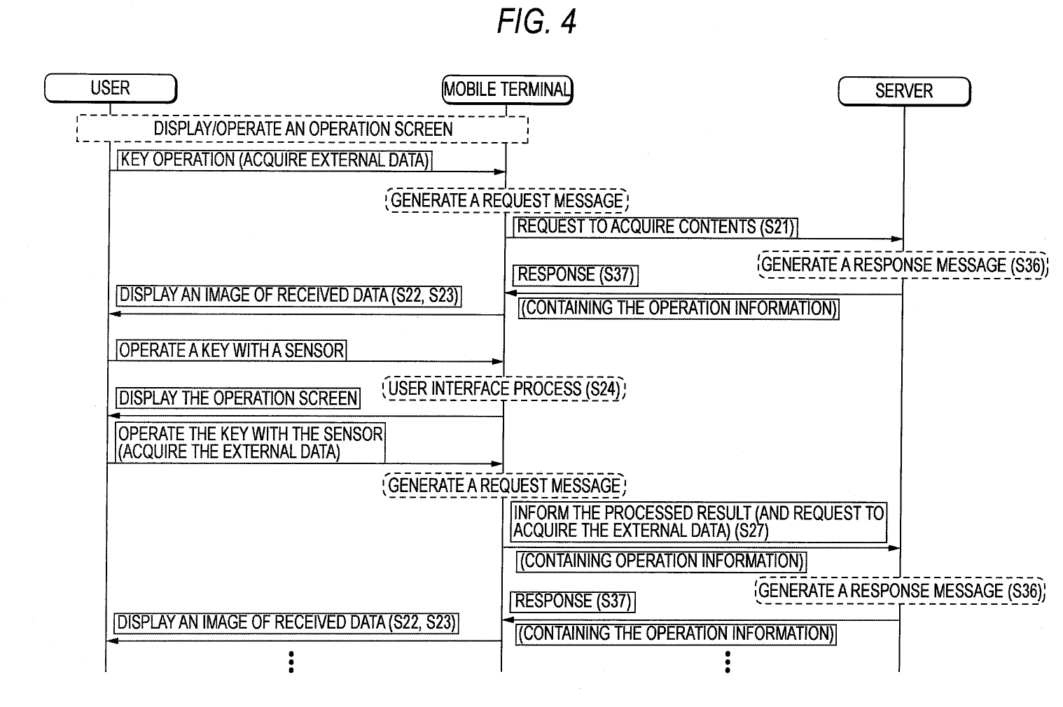

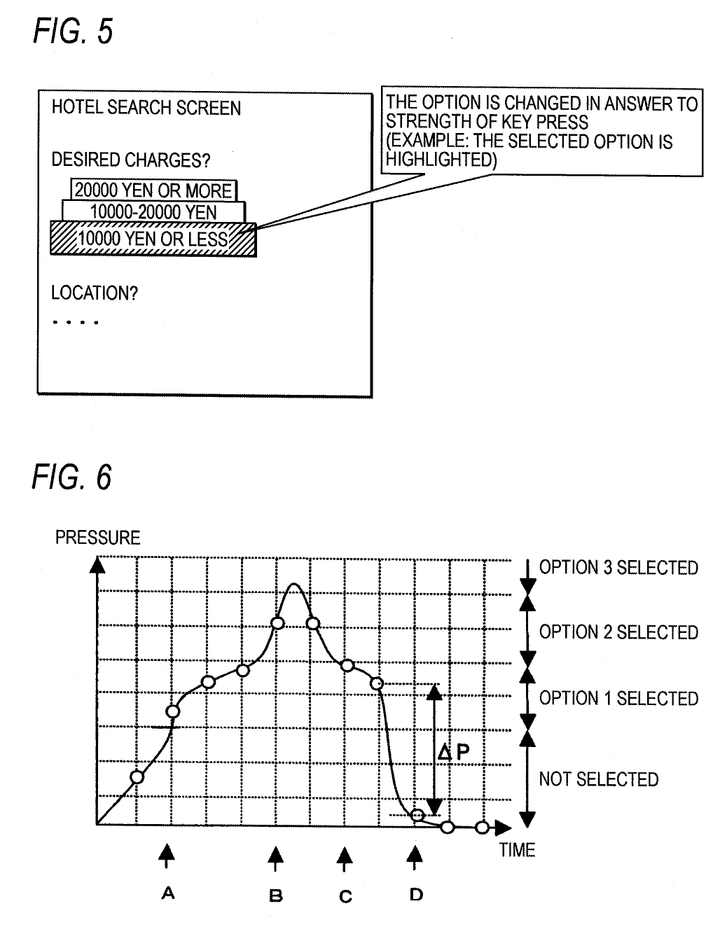

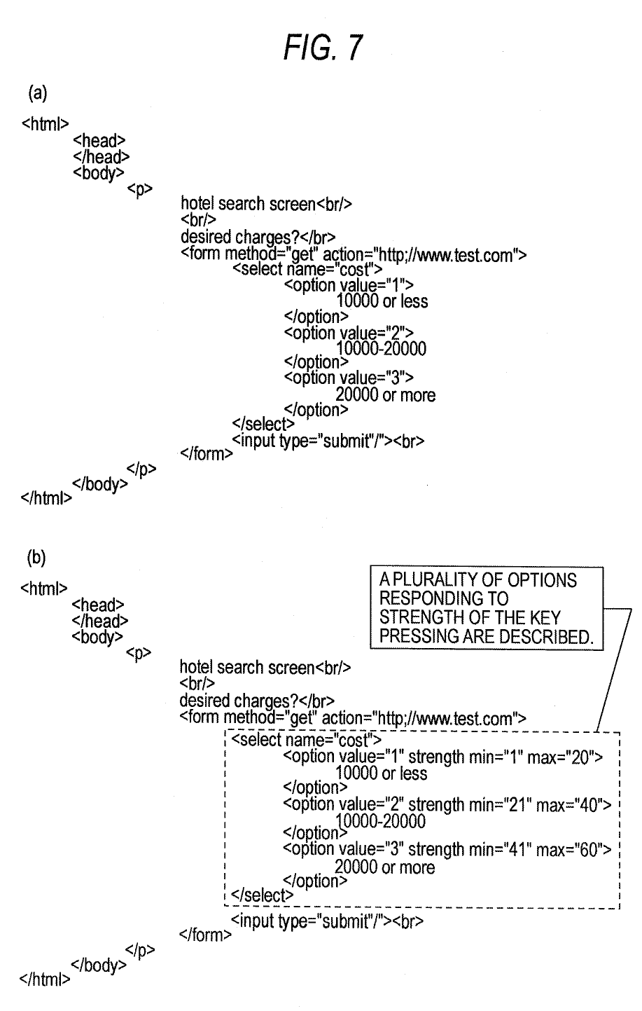

### BRIEF DESCRIPTION OF THE DRAWINGS

[FIG. 1] A block diagram of a network system.

[FIG. 2] A process flow in a mobile terminal.

[FIG. 3] A process flow in a server.

[FIG. 4] A sequence diagram showing procedures in communication between the mobile terminal and the server.

[FIG. 5] An example of a display of an option selection in a display portion of the mobile terminal.

[FIG. 6] An example of a decision in the option selection when a pressure sensor is used.

[FIG. 7] An example of an extension of a protocol statement.

### DESCRIPTION OF REFERENCE NUMERALS

100 mobile terminal
101 antenna
105 communication protocol controlling portion
107 information processing portion
109 information layout processing portion
111 operation controlling portion
113 acceleration sensing portion
115 acceleration sensor
117 pressure sensing portion
118 pressure sensor
119 button operation sensing portion
121 button
123 screen controlling portion
125 display
200 server
201 transmitting/receiving portion
203 communication protocol controlling portion
205 controlling portion
207 storage device
209 data generating portion
211 parameter processing portion
300 network system
400 network
500 base station

### Best Mode for Carrying Out the Invention

Embodiments of the present invention will be explained with reference to the drawings hereinafter. A network system 300 according to an embodiment of the present invention shown in FIG. 1 is constructed by a mobile terminal 100, a network server (server) 200, and a network (communication network) 400 for connecting both equipments. The mobile terminal 100 is connected to the network 400 by radio via a base station 500. The network 400 is constructed by the telephone network or the Internet.

The mobile terminal 100 includes an antenna 101, a transmitting/receiving portion 103, a communication protocol controlling portion 105, an information processing portion 107, an information layout processing portion 109, and an operation controlling portion 111. Also, the mobile terminal 100 includes an acceleration sensing portion 113, an acceleration sensor 115, a pressure sensing portion 117, a pressure sensor 118, a button operation sensing portion 119, a button 121, a screen controlling portion 123, and a display 125 composed of a liquid crystal display device.

The communication data transmitted from the server 200 via the network 400 and the base station 500 is received by the transmitting/receiving portion 103 via the antenna 101. Then, the received communication data (received data) is brought to communication protocol control by the communication protocol controlling portion 105, and then contents of the data are interpreted by the information processing portion 107. The information layout processing portion 109 executes various processes to display the analyzed received data on the display 125. The information processing portion 107 and the information layout processing portion 109 constitute an image generating portion that interprets the received data and generates an image representing operation information in the received data, as described later. Also, the information processing portion 107 constitutes a transmitted information generating portion that generates transmitted information containing designated information designated by the user who looked up the operation information displayed on the display 125, as described later.

The operation controlling portion 111 executes controls of other portions based on the user's operation of the mobile terminal 100, concretely the operation of the button 121 constituting an operation inputting portion. That is, the operation controlling portion 111 has a role as an interface between the user and the mobile terminal 100.

The button 121 is arranged on a case of the mobile terminal 100 or an external device connected to the case of the mobile terminal 100, and accepts the user's input. A shape, an arrangement position, etc. of the button 121 are not particularly restricted. Also, the button operation sensing portion 119 is provided to sense the operation of the button 121. The operation inputting portion used to input the user's operation of the mobile terminal 100 is constructed by the button operation sensing portion 119 and the button 121.

The acceleration sensing portion 113 and the acceleration sensor 115 or the pressure sensing portion 117 and the pressure sensor 118 constitute a sensing portion that senses the user's operation of the button 121 and senses an amount of physical operation (pressing force, pressing speed, pressing time, or the like) in such operation. Respective sensors 115, 117 can be formed of the material such as the piezoelectric device, or the like, which is deformed to generate a predetermined voltage (piezoelectric effect) when an expanding or contracting force, a bending force, or the like is applied from the external object. Shape, material, etc. of such piezoelectric material are not particularly restricted, and various shapes, materials, etc. can be utilized. Of course, the sensing device of other type can be employed.

In the present embodiment, two sensing devices of the sensing device for sensing an acceleration (the acceleration sensing portion 113 and the acceleration sensor 115) and the sensing device for sensing a pressure (the pressure sensing portion 117 and the pressure sensor 118) are provided. But only either of theses sensing devices can be provided.

The screen controlling portion 123 and the display 125 constitute a display portion for displaying an image. The screen controlling portion 123 fulfills a role of the driver for controlling the display 125, and displays the received data processed by the information layout processing portion 109 on the display 125. In the present embodiment, the display 125 is constructed by a pseudo three-dimensional display device.

The server 200 includes a transmitting/receiving portion 201, a communication protocol controlling portion 203, a controlling portion 205, a storage device 207, an information generating portion 209, and a parameter processing portion 211.

The communication data transmitted from the mobile terminal 100 via the base station 500 and the network 400 is received by the transmitting/receiving portion 201. Then, the received communication data (received data) is brought to communication protocol control by the communication protocol controlling portion 203.

Then, the controlling portion 205 controls the storage device 207, the information generating portion 209, and the parameter processing portion 211 in answer to the contents of the received communication data to apply the process to the communication data. The controlling portion 205 and the parameter processing portion 211 constitute a deciding portion that decides based on the received data whether or not transmission of the operation information responding to an amount of physical operation in the operation to the operation inputting portion of the mobile terminal 100 is needed. Also, the information generating portion 209 constitutes a transmitted information generating portion that generates the transmitted information containing the operation information when it is decided that the transmission of the operation information is needed.

Next, flows of processes in the mobile terminal 100 and the server 200 will be explained with reference to process flows hereunder.

FIG. 2 shows a process flow in the mobile terminal 100. First, the operation input of a request to acquire data such as predetermined program, contents, application, or the like (download) to the external device via the network 400 is applied by the user, and the request to acquire data is issued to the server 200 (step S21). Then, when received the data from the server 200 as the reply, the information processing portion 107 and the information layout processing portion 109 interpret the contents of the received data (step S22). Then, an image is generated based on the interpreted data, and then the screen controlling portion 123 displays the image on the display 125 (step S23). Then, a user's operation applied to the mobile terminal 100 is sensed (step S24), and then it is decided whether or not the operation corresponds to an ending operation of the terminal (step S25). If the operation is the ending operation (step S25; Yes), the process is ended.

If the operation is not the ending operation (step S25; No), it is decided whether or not the user's operation responds to an amount of physical operation like the pressure or the acceleration (whether or not the operation contains designated information) (step S26). If it is decided that the operation does not respond to an amount of physical operation (step S26; No), it is decided whether or not the operation corresponds to an operation to acquire the external data (request for a particular program) (step S27). If the operation is the operation to acquire the external data (step S27; Yes), the process goes back to step S22 wherein the request to acquire the data is issued. Then, the processes in step S22 et seq. are executed again. If the operation is not the operation to acquire the external data (step S27; No), the process goes back to step S23 where the predetermined image is displayed. Then, the processes in step S24 et seq. are executed once again.

In contrast, if it is decided that the user's operation responds to an amount of physical operation (step S26; Yes), contents of the user's operation (designated information) having an amount of physical operation as one of parameters is decided (step S28). Then, it is decided whether or not the operation corresponds to the ending operation of the terminal (step S29). If the operation is the ending operation (step S29; Yes), the process is ended. If the operation is not the ending operation (step S29; No), it is decided whether or not the operation corresponds to the operation to acquire the external data (step S27). If the operation is the operation to acquire the external data (step S27; Yes), the process goes back to step S21 wherein the request to acquire the data is issued. Then, the processes in step S22 et seq. are executed again. If the operation is not the operation to acquire the external data (step S27; No), the process goes back to step S23 wherein the predetermined image is displayed. Then, the processes in step S24 et seq. are executed once again.

FIG. 3 shows a process flow in the server 200. First, the server 200 waits for the request to acquire data (download) from the mobile terminal 100 (step S31). When the server 200 received the request (received information), contents of the request is interpreted (step S32). If the interpreted request is an ending request for the communication with the terminal 100 (step S33; Yes), the process goes back to step S31. The server 200 is brought into a standby state to wait the request again.

In contrast, if the interpreted request is not the ending request for the communication with the terminal 100 (step S33; No), it is decided whether or not the request corresponds to a request for operation information (parameter) regarding an amount of physical operation (request for a particular program) (step S34). Then, if the request is the request for operation information (step S34; Yes), a process of acquiring the operation information is carried out (step S35). Then, a message (transmitted information) to the terminal 100 is generated (step S36). In contrast, if the request is not the request for operation information regarding an amount of physical operation (step S34; No), a message to the terminal 100 is generated directly (step S36). Then, the generated message is transmitted (step S37). Then, the process goes back to step S31 wherein the server 200 is brought into a standby state to wait the request again.

Here, the process in step S35 depends upon the operation information in the acquiring request issued from the terminal. For example, the operation information can be processed in the parameter processing portion 211, and the particular program corresponding to the operation information or containing the operation information or the message can be generated in the information generating portion 209. Also, when the particular program is stored in the storage device 207, the corresponding program can be extracted from the storage device 207 and then the message can be formed in the data generating portion 209.

As described above, in step S27 in FIG. 2, the transmitted information containing the request for the operation information corresponding to an amount of physical operation is sent to the server 200. In other words, the mobile terminal 100 can inform the server 200 of the information of an amount of physical operation (strength, speed, time, or the like) by expanding the message that is used in informing the server 200 of the operated result in the mobile terminal 100. According to this process, the server 200 side can execute the process responding to an amount of physical operation made by the user of the mobile terminal 100 (steps S35 to S37).

FIG. 4 is a sequence diagram showing procedures in the communication between the mobile terminal 100 and the server 200, and shows the process flows shown in FIGS. 2 and 3 with the lapse of time. The transmitting/receiving procedures of the data, the message, and the like among the user, the mobile terminal 100, and the server 200 are shown. In this case, representations of (S21), and the like mean corresponding steps in FIG. 2 and FIG. 3.

FIG. 5 is an example of a display of the display 125 of the mobile terminal 100 in the present embodiment. In the present embodiment, a pseudo three-dimensional (pseudo 3D) display system is employed as the display of the display 125. Three options of 1) 10000 yen or less, 2) 10000-20000 yen, and 3) 20000 yen or more are prepared as a desired hotel charge on a hotel search screen displayed on the display 125. Also, the option is arranged in order of 1), 2), and 3) from this side on the pseudo three-dimensional display. That is, a pseudo depth display is realized on the pseudo three-dimensional display.

This pseudo depth corresponds to a pressing force applied to the button. When the user's pressing force on the button is weak, the option “10000 yen or less” on the nearest side is selected. When the pressing force on the button is increased, the option “10000-20000 yen” is selected. When the pressing force on the button is further increased, the option “20000 yen or more” is selected. In this manner, the option to be selected is changed in response to strength of the pressing force on the key. Now the selected option is highlighted. In this example, the option 1) as the selected object corresponds to the designated information. The designated information corresponds to an amount of physical operation made by the user, and indicates the object to be sensed by the sensing device.

In this manner, when the operation screen is represented by the pseudo three-dimensional display, a screen display can be updated in answer to an amount of physical operation (strength, speed, time, or the like) of the key operation, and thus a more intuitive operation can be accomplished.

In the above example, there may be supposed two situations after the option has been selected, i.e., the selection of the option 3) should be maintained as it is and the option should be changed to the option 2) or the option 1). Under such situations, it may be decided previously that, for example, the selection goes back to the option 2) or the option 1) when the key pressing is slowly released whereas the selection of the option 3) is maintained when the key pressing is quickly released.

FIG. 6 is an example of the decision in the option selection when a pressure sensor is employed. When a pressure exceeds a predetermined value within a predetermined time during the pressing operation, the option located on the deeper side on the pseudo three-dimensional display is selected. Concretely the operations are performed as follows.

A point of time A): Because a pressure value exceeds a threshold value, the selection of the option is started.

A point of time B): Because a pressure value exceeds an option boundary value, the selected option is changed (the option 1)→the option 2)).

A point of time C): Because a pressure value falls below the option boundary value, the selected option is changed (the option 2)→the option 1)).

A point of time D): Because a change in pressure AP per unit time exceeds a predetermined level, the selection of the option is ended.

Here, the above procedures show merely an example of the option selecting process using the pressure sensor. Other methods such as the method of deciding the selected option based on the maximum pressure value, and the like may be employed.

FIG. 7 shows an example of an extension of the protocol statement (specification of the description language, or the like) downloaded from the network server. This extended portion allows the mobile terminal to represent a pseudo three-dimensional operation screen on the display. In this example, the description language as the base is HTML (Hyper Text Markup Language). FIG. 7(a) is an example of the description language in the prior art. In contrast, as shown in FIG. 7(b), the description language of the present invention contains the description concerning a plurality of options that are selected in response to strength of the pressing force on the key (extended portion). This description corresponds to the above operation information.

Among this description, a portion of <option value=“1” strength min=“1” max=“20”>corresponds to the selection of the foregoing option 1) in FIG. 5. The option 1) is selected when the pressing force of the key is in a range of 1 to 20 (unit is arbitrary).

The mobile terminal used in the present invention is not particularly limited. Any mobile terminal may be employed if such terminal can communicate with the server via the network. As an example of the mobile terminal, there are mobile phone, PHS, PDA, portable TV phone, personal computer, and the like. Also, the application of the present invention is not limited to them.

Also, various shapes of the operation inputting portion in the mobile terminal can be considered. Not only the push button but also the stick, the slide button, the crosshairs key, or the like can be employed. The sensing device can be built in the mobile terminal in answer to the shape.

Also, in the above embodiment, an amount of physical operation as the sensed object of the sensing device is a pressing force (pressure) of the button or a pressing time of the button. But other physical quantity may be employed as the sensed object. For example, a pressing speed of the button may be employed as the sensed object. All physical quantities may be employed as an amount of physical operation if such physical quantity can give any physical or mechanical index regarding the user's operation applied to the operation inputting portion. For example, an amount of deformation of the operation inputting portion may be employed as an amount of physical operation.

In addition, in the above embodiment, the pseudo three-dimensional display constructed by the ordinary two-dimensional liquid crystal display is basically employed. But three-dimensional liquid crystal display can also be employed. Further, the type of the display is not limited. Any device such as the organic EL, the electronic paper, or the like may be employed if such device can express the operation information corresponding to an amount of physical operation and also the user can designate the designated information by using such device. Also, the image representing the operation information is not always displayed three dimensionally, and such image may be display two dimensionally. For example, the image display where the bar graph extends in response to a pressing force of the button can be attained by the two-dimensional display. Various modes can be employed if the image can represent the operation information, and the type is not restricted.

Besides, the external data requested from the mobile terminal are various programs, contents, applications, and the like. The external data are not particularly restricted if such data contain the operation information therein.

Moreover, the type of the description language is not limited to HTML. Various languages such as WML (Wireless Markup Language), SVG (Scalable Vector Graphics), VRML (Virtual Reality Modeling Language), and the like can be employed.

Also, the above network communication method is contained in the present invention. Also, the program of causing the computer constituting the network server to execute respective steps of this communication method is contained in the present invention. Such program is incorporated into the overall system in various formats. For example, the program can be recorded in a predetermined memory in the network server or in the external device of the network server. Also, the program may be recorded in the information recording device such as a hard disk, or the like or the information recording medium such as CD-ROM, DVD-ROM, memory card, or the like.

With the above, various embodiments of the present invention are explained, but the present invention is not restricted to the matters disclosed in above embodiments. The present invention is susceptible to variations and modifications made by those skilled in the art based on the recitations of the specification and the drawings and the well-known technologies, and these matters are contained in a scope of protection.

This application is based upon Japanese Patent Application (Patent Application No. 2005-018522) filed on Jan. 26, 2005; the contents of which are incorporated herein by reference.

### INDUSTRIAL APPLICABILITY

According to the present invention, the technology that is capable of causing the operation keys of the mobile terminal to flexibly deal with the external data such as the new program, or the like, and also improving an operability of the mobile terminal in handling the external data can be provided.

1: A mobile terminal, comprising:
an operation inputting portion that inputs a user's operation;
a sensing device that senses the user's operation applied to the operation inputting portion and senses an amount of physical operation in the operation;
a receiving portion that receives received information containing operation information corresponding to the amount of physical operation from an outside;
an image generating portion that generates an image representing the operation information by interpreting the received information;
a displaying portion that displays the image;
a transmitted information generating portion that generates transmitted information containing designated information designated by the user who looks up the operation information in the displayed image; and
a transmitting portion that transmits the transmitted information to the outside,
wherein the designated information responds to the amount of physical operation in the user's operation applied to the operation inputting portion, and is sensed by the sensing device.

2: The mobile terminal according to claim 1, wherein the received information is composed of a language containing a supplementary description corresponding to the operation information.

3: The mobile terminal according to claim 1, wherein the display portion displays a pseudo three-dimensional screen.

4: The mobile terminal according to claim 1, wherein the operation inputting portion is constructed by a button; and
wherein the amount of physical operation corresponds to at least one of a pressing force on the button, a pressing speed on the button, and a pressing time on the button.

5: The mobile terminal according to claim 4, wherein the display portion displays a pseudo three-dimensional screen; and
wherein the pseudo three-dimensional screen represents a pseudo depth display corresponding to at least one of the pressing force, the pressing speed, and the pressing time on the button when the operation information is represented by a three-dimensional display.

6: A network server which is able to communicate with a mobile terminal via a network, comprising:
a receiving portion that receives received information from the mobile terminal;
a deciding portion that decides whether or not the received information contains a request for operation information corresponding to an amount of physical operation of an operation applied to an operation inputting portion of the mobile terminal;
a transmitted information generating portion that generates transmitted information containing the operation information when it is decided that the received information contains the request for the operation information; and
a transmitting portion that transmits the transmitted information to the mobile terminal.

7: The network server according to claim 6, further comprising a storage device that stores the operation information.

8: A network system, comprising:
a mobile terminal that transmits/receives transmitted information and received information containing operation information that corresponds to an amount of physical operation in a user's operation applied to an operation inputting portion;
a network server that receives the transmitted information to generate information containing the operation information, and transmits the information to the mobile terminal; and
a network that connects the mobile terminal and the network server to allow mutual communication.

9: A network communicating method, comprising:
receiving received information from a mobile terminal;
deciding whether or not transmission of operation information corresponding to an amount of physical operation in an operation applied to an operation inputting portion of the mobile terminal is needed, based on the received information; and
generating transmitted information containing the operation information when it is decided that the transmission of the operation information is needed, and transmitting the transmitted information to the mobile terminal.

10: A program of causing a computer to execute respective steps set forth in claim 9.

11: The mobile terminal according to claim 2, wherein the display portion displays a pseudo three-dimensional screen.
